(19) United States
(12) Patent Application Publication
(10) Pub. No.: US 2025/0100832 A1
(43) Pub. Date: Mar. 27, 2025

(54) Manufacturing Machine and Method for Manufacturing a Cylindrical Electrochemical Cell

(71) Applicant: G.D S.P.A., Bologna (IT)

(72) Inventors: Andrea Biondi, Bologna (IT); Enrico Campagnoli, Bologna (IT); Luca Cavazza, Bologna (IT); Ivanoe Bertuzzi, Bologna (IT); Fabrizio Nanni, Bologna (IT)

(21) Appl. No.: 18/722,577

(22) PCT Filed: Dec. 21, 2022
(86) PCT No.: PCT/IB2022/062593

§ 371 Date: Jun. 20, 2024

(30) Foreign Application Priority Data
Dec. 21, 2021 (IT) 102021000032009
Apr. 22, 2022 (IT) 102022000008033

(51) Int. Cl. B65H 18/10; H01M 10/04; H01M 50/107

(52) U.S. Cl. CPC B65H 18/103; H01M 10/0409; H01M 10/0431; H01M 50/107; B65H 2301/41429; B65H 2701/19

(57) ABSTRACT

Manufacturing machine (9) and method for manufacturing a cylindrical electrochemical cell (2) consisting of a spiral winding of a composite material (8) comprising at least two conductor bands (4, 6) and at least two separator bands (5, 7) overlapping one another. They are provided: a plurality of winding heads (13), each of which supports a holding device (14) which is configured to grab an end of the composite material (8) and to rotate on itself around a first rotation axis (15) so as to obtain a spiral winding of the composite material (8); a drum (11) which supports the winding heads (13) and which is mounted in a rotary manner so as to rotate with a continuous law of motion around a second rotation axis (12) in order to move the winding heads (13) along a processing path (P2); and a feeding unit (10) configured to feed the composite material (8) to the winding heads (13).

### SECTOR OF THE ART

The present invention relates to a manufacturing machine and a method for manufacturing an electrochemical cell.

The present invention is advantageously applied to the production of a cylindrical lithium-ion battery, to which the hereinafter description will make explicit reference without losing generality.

### PRIOR ART

Commercial lithium-ion batteries are assembled in three different geometries: cylindrical, prismatic and pouch.

Cylindrical batteries consist of a cylinder-shaped metal container with a single electrochemical cell therein, consisting of an anode, separators and cathode rolled with each other.

In particular, the cylindrical container is initially open on one side (i.e. it is cup-shaped with a closed lower end and an open upper end) to allow introducing the wound electrochemical cell and the electrolyte impregnating the wound electrochemical cell; once the battery has been formed (i.e. once all the components have been arranged inside the cylindrical container), the open end of the cylindrical container is closed, forming a sealed closure.

Forming a cylindrical electrochemical cell involves feeding a composite material (comprising at least two conductor bands and at least two separator bands overlapping one another) to a winding head provided with a holding device which is configured to grab one end of the composite material and to rotate on itself around a central rotation axis so as to obtain a spiral winding of the composite material.

A known manufacturing machine comprises a vertically arranged drum which supports a plurality of winding heads and is mounted in a rotary manner to rotate around a horizontal rotation axis in order to move the winding heads along a perfectly circular processing path; in addition, a known manufacturing machine comprises a feeding unit configured to feed the composite material to the winding heads. In particular, in a known manufacturing machine, the drum rotates around its own rotation axis with an intermittent (stepped) law of motion which involves cyclically alternating motion steps in which the drum rotates and standstill steps in which the drum remains stationary.

It has been observed that known manufacturing machines are unable to achieve high production speeds (measured as cylindrical electrochemical cells produced in the unit of time) if not to the detriment of the quality of the final product. In order to ensure compliance with a high quality of the final product, known manufacturing machines must necessarily operate at limited production speeds (roughly in the order of 15 to 20 cylindrical electrochemical cells produced per minute).

### DISCLOSURE OF THE INVENTION

The object of the present invention is to provide a manufacturing machine and a method for manufacturing an electrochemical cell that enables it to operate at a high production speed (measured as cylindrical electrochemical cells produced in a unit of time) while ensuring a high quality of the final product.

The present invention, in a first aspect thereof, therefore relates to a machine for manufacturing a cylindrical electrochemical cell, consisting of a spiral winding of a composite material preferably comprising at least two conductor bands and at least two separator bands overlapping one another.

Preferably the manufacturing machine comprises a plurality of winding heads.

Preferably each of the winding heads supports a holding device which is configured to grab one end of the composite material.

Preferably, said holding device is configured so as to create said spiral winding of the composite material.

Preferably, said holding device is configured to rotate on itself around a first rotation axis in order to create said spiral winding of the composite material.

Preferably said manufacturing machine comprises a drum which supports the winding heads.

Preferably, said head is mounted in a rotary manner so as to rotate around a second rotation axis in order to move the winding heads along a processing path.

Preferably, said manufacturing machine comprises a feeding unit configured to feed the composite material to the winding heads.

Preferably the drum rotates around the second rotation axis with a continuous law of motion

The present invention, in a second aspect thereof, relates to a method for manufacturing an electrochemical cell, preferably cylindrical, consisting of a spiral winding of a composite material preferably comprising at least two conductor bands and at least two separator bands overlapping one another.

Preferably, the manufacturing method comprises rotating a holding device which is configured to grab an end of the composite material on itself around a first rotation axis so as to obtain a spiral winding of the composite material.

Preferably said holding device is supported by a winding head.

Preferably, the method comprises moving a plurality of winding heads along a processing path.

Preferably said moving a plurality of winding heads occurs by means of a drum which supports the winding heads and which is mounted in a rotary manner to rotate around a second rotation axis.

Preferably said method comprises feeding the composite material to the winding heads by means of a feeding unit.

Preferably, the drum rotates around the second rotation axis with a continuous law of motion.

The present invention, in at least one of the aforesaid aspects, may also have at least one of the further preferred features listed hereinafter.

Preferably, said feeding unit is configured to move the composite material at a substantially constant moving speed.

Preferably said feeding unit is configured to move the material without any interruption of the movement of the composite material.

Preferably said feeding unit is configured to move the composite material at a substantially constant moving speed and thus without any interruption of the movement of the composite material.

Preferably said feeding unit is configured to move the composite material along a straight feeding path.

Preferably the straight feeding path is arranged vertically.

Preferably the feeding unit is configured to move the composite material from the top to the bottom.

Preferably a segment of the processing path is substantially straight and parallel to the feeding path.

Preferably a segment of the processing path is substantially straight.

Preferably each holding device is configured to grab one end of the composite material.

Preferably, each holding device is configured to start the spiral winding of the composite material while the corresponding winding head moves along the substantially straight segment of the processing path.

Preferably, each holding device is configured to grab one end of the composite material and hence start the spiral winding of the composite material while the corresponding winding head moves along the substantially straight segment of the processing path.

Preferably said manufacturing machine comprises a first cutting device which is configured to cut the composite material.

Preferably said first cutting device is configured to cut composite material.

Preferably said first cutting device is configured to create a new free end of the composite material while the composite material is still being wound by a first winding head.

Preferably said first cutting device is configured to cut the composite material and hence create a new free end of the composite material while the composite material is still being wound by a first winding head.

Preferably, the manufacturing machine comprises a second winding head which follows the first winding head along the processing path.

Preferably the second head is configured to grab the new free end of the composite material while the first winding head is still completing the winding of its own composite material.

Preferably said second winding head, which follows the first winding head along the processing path, is configured to grab the new free end of the composite material and start the winding of the composite material while the first winding head is still completing the winding of its own composite material.

Preferably, the drum is configured to place the first winding head and the second winding head at the minimum mutual distance along the processing path at the instant in which the first cutting device cuts the composite material.

Preferably said feeding unit comprises two opposite compression rollers between which the composite material is passed.

Preferably the first cutting device is arranged downstream of the two compression rollers.

Preferably the first cutting device is mounted, in a movable manner, to move back and forth along a segment of the feeding path.

Preferably the manufacturing machine comprises an actuator device which is configured to have the first cutting device cyclically cover a forth stroke in which the first cutting device follows, in a synchronous manner, a winding head along a segment of the processing path, and a return stroke, in which the first cutting device moves back to a start position in order to follow, in a synchronous manner, a following winding head.

Preferably said first cutting device is configured to cut the composite material at the end of the forth stroke.

Preferably the holding device of each winding head is configured to grab one end of the composite material.

Preferably, the holding device of each winding head is configured to start creating the spiral winding immediately after the first cutting device has cut the composite material.

Preferably, the holding device of each winding head is configured to grab one end of the composite material and hence start creating the spiral winding immediately after the first cutting device has cut the composite material.

Preferably, the holding device of the winding head arranged closest to the first cutting device is configured to start creating the spiral winding immediately after the first cutting device has cut the composite material.

Preferably, the holding device of the winding head arranged closest to the first cutting device is configured to grab one end of the composite material and hence start to create the spiral winding immediately after the first cutting device has cut the composite material.

Preferably when the composite material is cut by the first cutting device, the winding head arranged closest to the first cutting device is located upstream of the first cutting device relative to the moving direction of the composite material.

Preferably, the first cutting device comprises a first side board that has a face parallel to a feeding path followed by the composite material.

Preferably, the first cutting device comprises a blade slidably mounted in relation to the second side board.

Preferably, each winding head comprises a second side board, which, along a segment of the processing path, is arranged facing the first side board so as to define with the first side board a channel in which the composite material is located.

Preferably, each winding head comprises a third side board, which is arranged next to the holding device on the side opposite the second side board.

Preferably the feeding unit comprises two second cutting devices, each of which is configured to cut only a corresponding conductor band.

Preferably the feeding unit comprises two opposite compression rollers between which the composite material is passed.

Preferably each second cutting device is arranged upstream of the two compression rollers.

Preferably each winding head is mounted in a rotary manner on the drum to rotate, relative to the drum itself, around a third rotation axis, preferably parallel to the second rotation axis.

Preferably each winding head is mounted in a rotary manner on the drum to rotate, relative to the drum itself, around a third rotation axis, preferably parallel to the second rotation axis.

Preferably each winding head is mounted in a rotary manner on the drum to rotate, relative to the drum itself, around a fourth rotation axis, preferably parallel to the second rotation axis.

Preferably each winding head is hinged at an end of a first arm so as to rotate relative to the first arm.

Preferably each winding head is hinged at said end of said first arm to rotate relative to the first arm around the fifth rotation axis.

Preferably one end of the first arm opposite the winding head is hinged at an end of a second arm to rotate relative to the second arm preferably around the fourth rotation axis.

Preferably one end of the second arm opposite the first arm is hinged to the drum to rotate relative to the drum around the third rotation axis.

Preferably the feeding unit is mounted in a movable manner so as to move back and forth along a segment of the processing path.

Preferably the feeding unit is mounted in a rotary manner, preferably to rotate around the second rotation axis.

Preferably the manufacturing machine comprises an actuator device which is configured to have the feeding unit cyclically cover a forth stroke in which the feeding unit follows, in a synchronous manner, a winding head along a segment of the processing path and a return stroke in which the feeding unit moves back to a start position in order to follow, in a synchronous manner, a subsequent winding head.

The claims describe embodiments of the present invention forming an integral part of the present disclosure.

### BRIEF DESCRIPTION OF THE DRAWINGS

The present invention will now be described with reference to the accompanying drawings, which show a non-limiting embodiment thereof, wherein:

FIG. 1 is a schematic view of a cylindrical battery;

FIG. 2 is a schematic view of a cylindrical electrochemical cell of the cylindrical battery of FIG. 1;

FIG. 3 is a schematic and frontal view of a manufacturing machine that makes the cylindrical electrochemical cell of FIG. 1;

FIG. 4 is a schematic and frontal view of a feeding unit of the manufacturing machine of FIG. 3;

FIGS. 5-8 are four schematic and frontal views of a drum of the manufacturing machine of FIG. 3 at different operation instants; and

FIG. 9 is a schematic and perspective view of a variant of the drum of FIGS. 5-8.

### PREFERRED EMBODIMENTS OF THE INVENTION

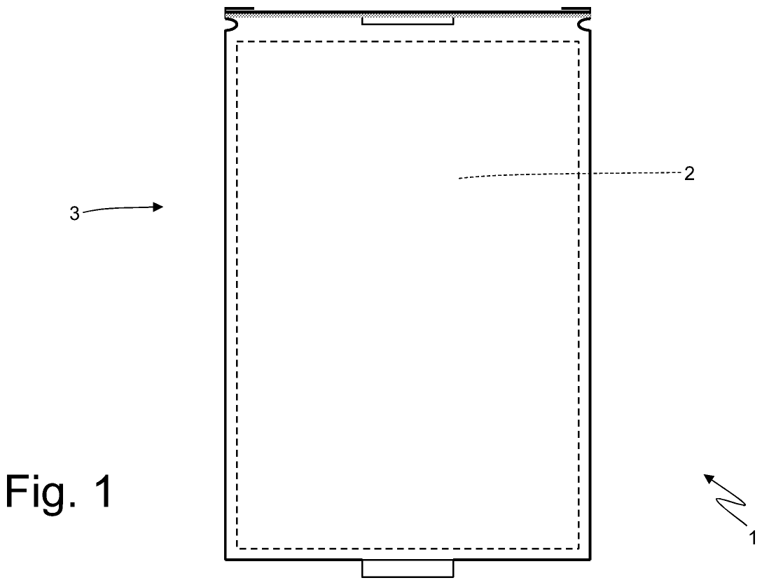

In FIG. 1 an electric power cylindrical battery is globally referred to by number 1.

The cylindrical battery 1 comprises an electrochemical cell 2 of the “jelly-roll” or “swiss-roll” type made up of several sheets wound together to take on a cylindrical shape, and a cylindrical container 3 enclosing therein the electrochemical cell 2.

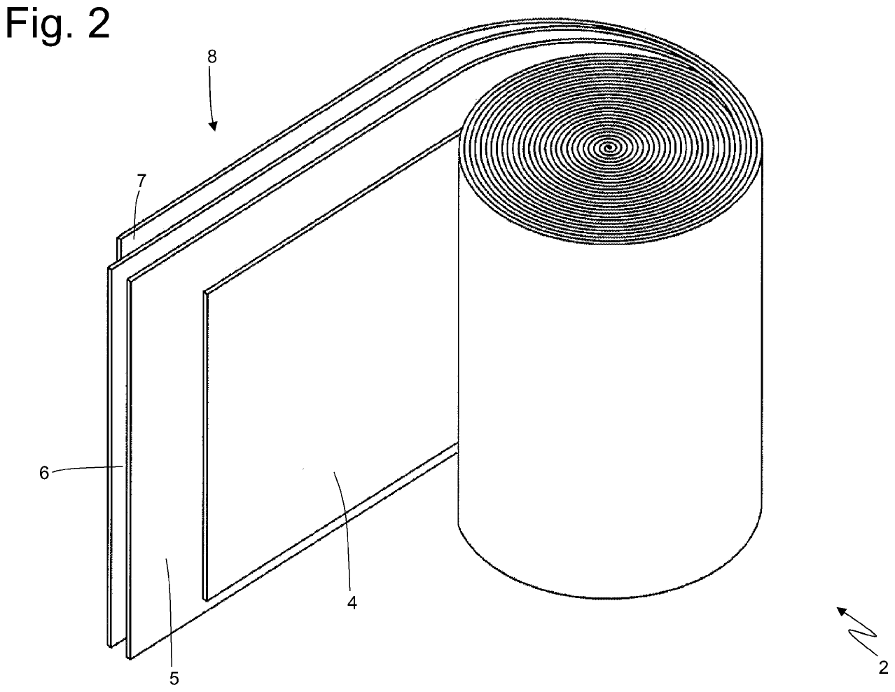

As shown in FIG. 2, the cylindrical electrochemical cell 2 consists of the spiral winding of a set of four bands: a conductor band 4 made of a metal-based material (typically aluminium) constituting the cathode, a separator band 5 made of a porous material (which is subsequently soaked in a liquid electrolyte), a conductor band 6 made of a metal-based material (typically copper) constituting the anode, and a separator band 7 made of a porous material (which is subsequently soaked in a liquid electrolyte). In other words, the four overlapping bands 4-7 form a composite material 8 (i.e. a “sandwich” of the four bands 4-7) that is spirally wound around itself to form the cylindrical electrochemical cell 2.

According to a preferred embodiment, in the initial part and in the final part (i.e. for a small segment at the head and for a small segment at the back end), the composite material 8 is formed only by the two overlapping separator bands 5 and 7; in other words, the composite material 8 is not uniform along its entire length since only in the (large) central part is the composite material 8 formed by the overlapping of all the four overlapping bands 4-7, whereas in the initial part and in the final part the composite material 8 is formed only by the two overlapping separator bands 5 and 7. This expedient allows the electrical insulation at the beginning and end of the cylindrical electrochemical cell 2 to be increased, reducing the risk of undesired short circuits.

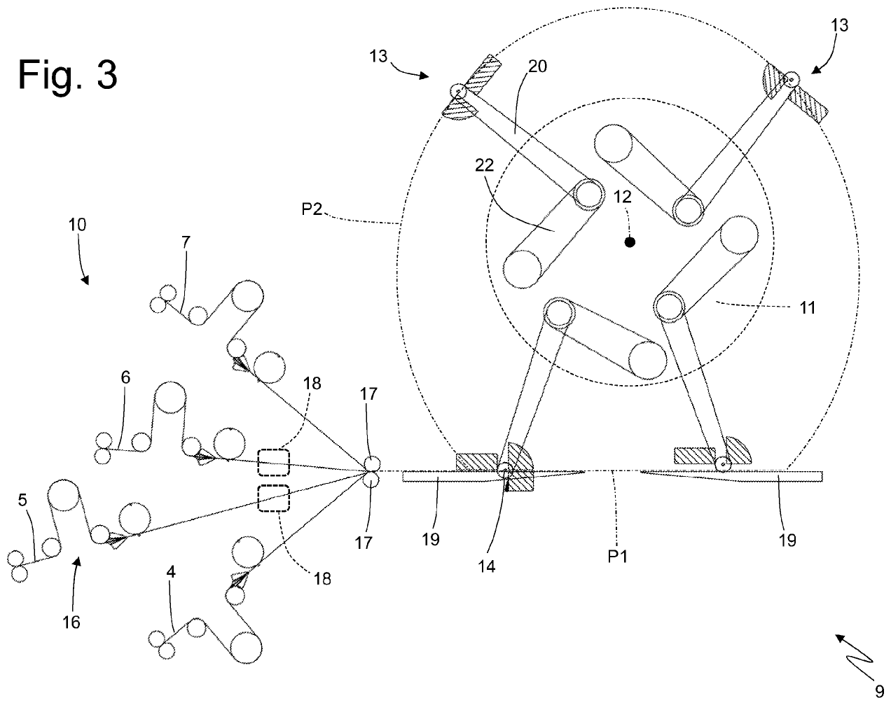

In FIG. 3, a manufacturing machine which manufactures the cylindrical electrochemical cell 2 is globally referred to by number 9.

The manufacturing machine 9 comprises a feeding unit 10 which is configured to feed the composite material 8 (formed by the bands 4-7 overlapping one another) along a straight, vertically oriented feeding path P1; preferably, the feeding unit 10 is configured to move the composite material 8 from the top to the bottom to take advantage of the force of gravity (i.e., the force of gravity tends to push the composite material 8 along the feeding path P1 without causing the composite material 8 to deviate from the feeding path P1).

In particular, the feeding unit 10 is configured to move the composite material 8 along the feeding path P1 at a constant moving speed at all times and thus without any interruption of the movement of the composite material 8. In other words, the composite material 8 exits the feeding unit 10 according to a continuous law of motion, i.e., with a law of motion that provides for movement with no stops at a constant moving speed (which obviously increases or decreases as the hourly output, at which the manufacturing machine 9 operates, increases or decreases); that is, the composite material 8 exiting the feeding unit 10 does not cyclically alternate standstill steps and motion steps but moves with an always equal speed.

The manufacturing machine 9 comprises a drum 11 (vertically oriented) which is mounted in a rotary manner around a horizontal rotation axis 12 (perpendicular to the sheet plane) and supports a plurality of winding heads 13. The drum 11 rotates around the rotation axis 12 with a continuous law of motion, i.e. with a law of motion that provides for movement without stops at a constant moving speed (which obviously increases or decreases as the hourly productivity, with which the manufacturing machine 9 operates, increases or decreases); i.e. the drum 11 does not cyclically alternate standstill steps and motion steps but rotates around the rotation axis 12 with an angular speed that is always the same.

The rotation of the drum 11 around the rotation axis 12 causes each winding head 13 to move along a close-shaped processing path P2. A segment of the processing path P2 is substantially straight and parallel to the feeding path P1 (hence it is arranged substantially vertically); i.e. a straight segment of the processing path P2 substantially coincides with a corresponding segment of the feeding path P1.

Each winding head 13 comprises a holding device 14 which is configured to grab one end of the composite material 8 and to rotate on itself around a rotation axis 15 (horizontal and parallel to the rotation axis 12) so as to obtain a spiral winding of the composite material 8 (i.e. so as to obtain a corresponding cylindrical electrochemical cell 2). Preferably, each winding head 13 supports an electric motor which carries out the rotation of the holding device 14 around the rotation axis 15.

According to a preferred embodiment and as will be more fully described below, each holding device 14 is configured to grab one end of the composite material 8 and hence start the spiral winding of the composite material 8 while the corresponding winding head 13 moves along the substantially straight segment of the processing path P2.

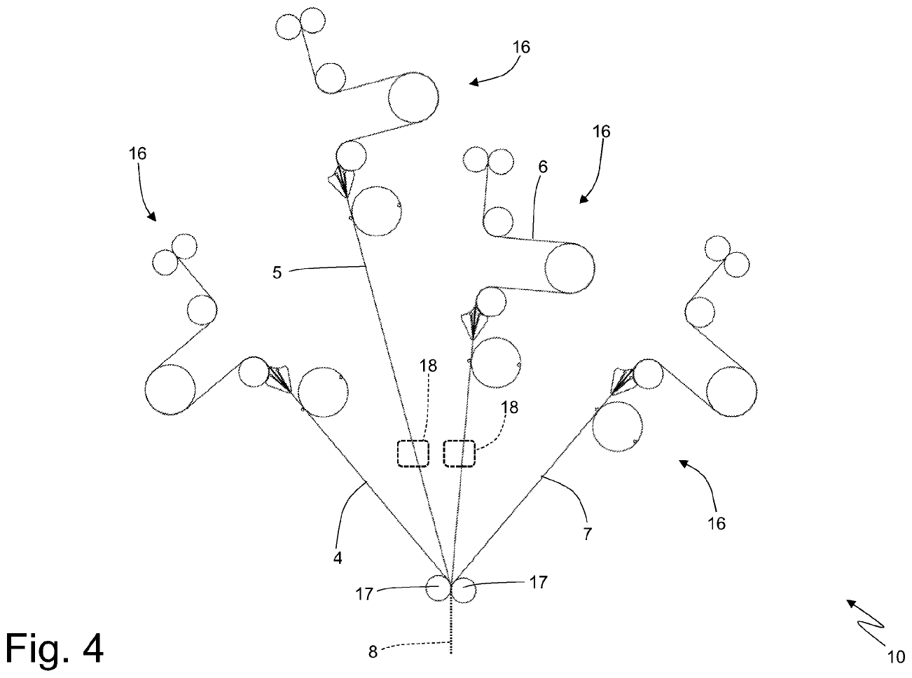

As better shown in FIG. 4, the feeding unit 10 comprises four unwinding devices 16 which unwind the composite material 8 from corresponding coils (not shown) and move the composite material 8 to two compression rollers 17 that press the composite material 8 between them so as to obtain an optimal overlapping of the composite material 8. Each unwinding device 16 comprises tensioning members which apply and maintain the corresponding composite material 8 (formed by the overlapping bands 4-7) at a constant tension equal to a desired value. The feeding unit 10 comprises two cutting devices 18, each of which is configured to cut only a corresponding conductor band 4 or 6 and is arranged upstream of the two compression rollers 17; i.e. each cutting device 18 is operable to cut only a corresponding conductor band 4 or 6 before the conductor band 4 or 6 reaches the two compression rollers 17.

As better shown in FIG. 3, the feeding unit 10 comprises fixed guides 19 (not shown for the sake of clarity in the following figures) which are arranged downstream of the compression rollers 17 with respect to the moving direction of the composite material 8 and serve to guide the movement of the composite material 8 along the feeding path P1.

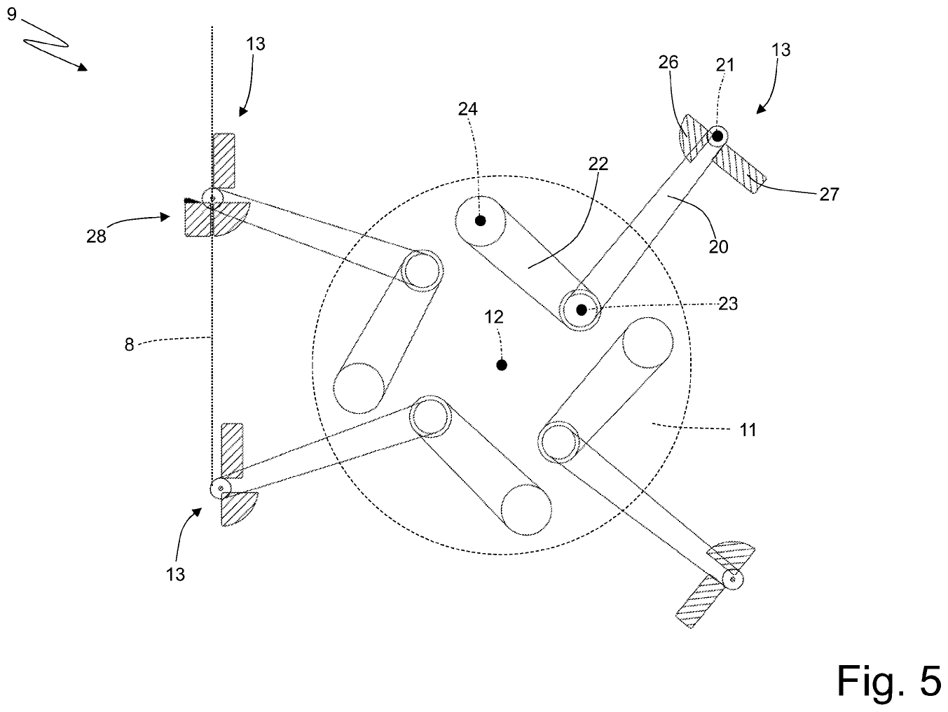

According to what shown in FIGS. 5-9, each winding head 13 is mounted (hinged) in a rotary manner at the end of an arm 20 to rotate relative to the arm 20 around a rotation axis 21 parallel to the rotation axis 12; in each winding head 13, the rotation axis 21 is parallel to the rotation axis 15 of the corresponding holding device 14 and may be coaxial to the rotation axis 15 or (slightly) spaced from the rotation axis 15. Each arm 20 has one end which supports the corresponding winding head 13 and an opposite end which is mounted (hinged) in a rotary manner to the end of an arm 22 to rotate relative to the arm 22 around a rotation axis 23 parallel to the rotation axis 12.

Each arm 22 has one end which supports the arm 20 and an opposite end which is mounted (hinged) in a rotary manner to the drum 11 to rotate relative to the drum 11 around a rotation axis 24 parallel to the rotation axis 12.

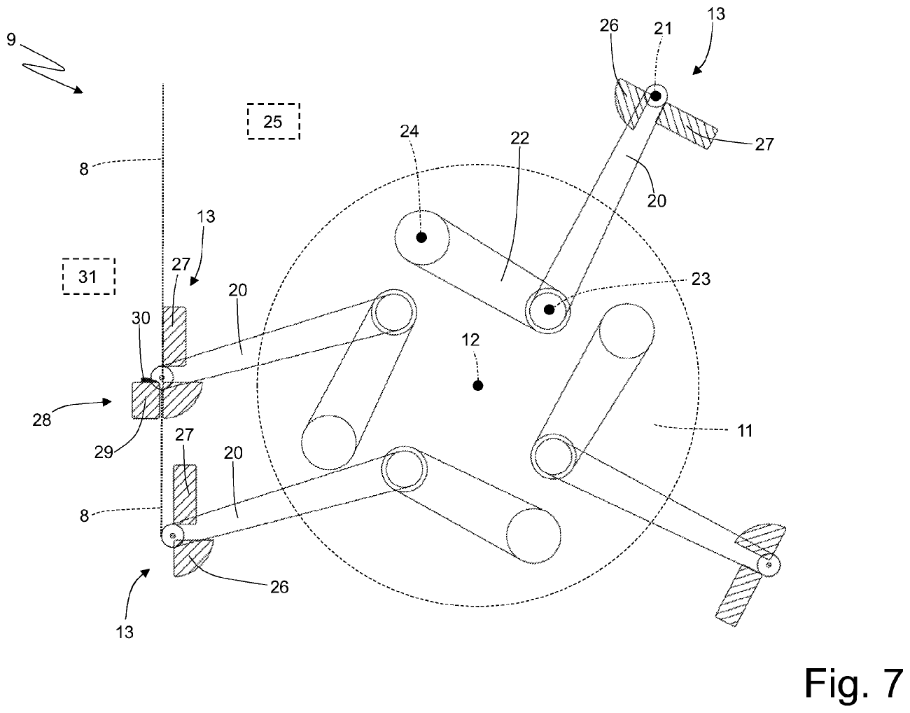

The drum 11 comprises an actuating system 25 (schematically shown in FIG. 7) which controls the position of the winding heads 13 relative to the drum 11, i.e., it controls the rotations around the rotation axes 21, 23 and 24; preferably, the actuating system 25 uses fixed cams which are arranged inside the drum 11 and generate movement by exploiting the rotation of the drum 11 around the rotation axis 12.

Each winding head 13 comprises, in addition to the holding device 14, a side board 26 and a side board 27 which are arranged on opposite sides of the holding device 14; in particular, the side board 26 is arranged downstream relative to the moving direction along the processing path P2 while the side board 27 is arranged upstream relative to the moving direction along the processing path P2. The side boards 26 and 27 are designed to help guide the movement of the composite material 8 along the feeding path P1 and therefore have flat surfaces facing, in use, the feeding path P1.

The manufacturing machine 9 comprises a cutting device 28 which is configured to cut the composite material 8 and is movably mounted to move back and forth along a segment of the feeding path P1; accordingly, the cutting device 28 is placed downstream of the two compression rollers 17 of the feeding unit 10.

The cutting device 28 comprises a side board 29 which is designed to help guide the movement of the composite material 8 along the feeding path P1 and has a face parallel to the feeding path P1.

In addition, the cutting device 28 comprises a blade 30 mounted, in a sliding manner, relative to the side board 29. In use and as will be better described below, the side board 29 of the cutting device 28 is arranged facing the side board 26 of a corresponding winding head 13 along the substantially straight segment of the processing path P2 (parallel to the feeding path P1) so as to define with the side board 26 a channel in which the composite material 8 is located.

The cutting device 28 comprises an actuator device 31 (typically provided with its own independent electric motor) which is configured to have the cutting device 28 cyclically cover a forth stroke in which the cutting device 28 follows, in a synchronous manner, a winding head 13 along the substantially straight segment of the processing path P2 (parallel to the feeding path P1) and a return stroke in which the cutting device 28 moves back to a start position in order to follow, in a synchronous manner, a subsequent winding head 13.

With reference to FIGS. 5-8, the operation of the manufacturing machine 9 is hereinafter described by describing the manufacturing of a cylindrical electrochemical cell 2 by winding a strip of composite material 8 into a winding head 13 (shown on the top left in FIG. 5).

According to what shown in FIG. 5, initially a previous winding head 13 (i.e. arranged downstream of the new winding head 13 along the processing path P2 and shown on the bottom left in FIG. 5) is winding its own strip of composite material 8 by rotating its own holding device 14 on itself, in these conditions, the new winding head 13 (shown on the top left in FIG. 5) which is not winding and is not engaging the composite material 8 with its own holding device 14 arrives at the beginning of the substantially straight (and vertical) segment of the processing path P2.

When the new winding head 13 (shown on the top left in FIG. 5), which is not winding and is not engaging the composite material 8, arrives at the beginning of the substantially rectilinear (and vertical) segment of the processing path P2, it meets with the cutting device 28 which is arranged (at the beginning of its forth stroke) facing the winding head 13; at this time, i.e. at the beginning 1s of the substantially rectilinear segment of the processing path P2, the side board 29 of the cutting device 28 is arranged facing the side board 26 of the winding head 13 to define with the side board 26 a channel in which the composite material 8 is located; i.e. the two side boards 26 and 29 enclose the composite material 8 between them.

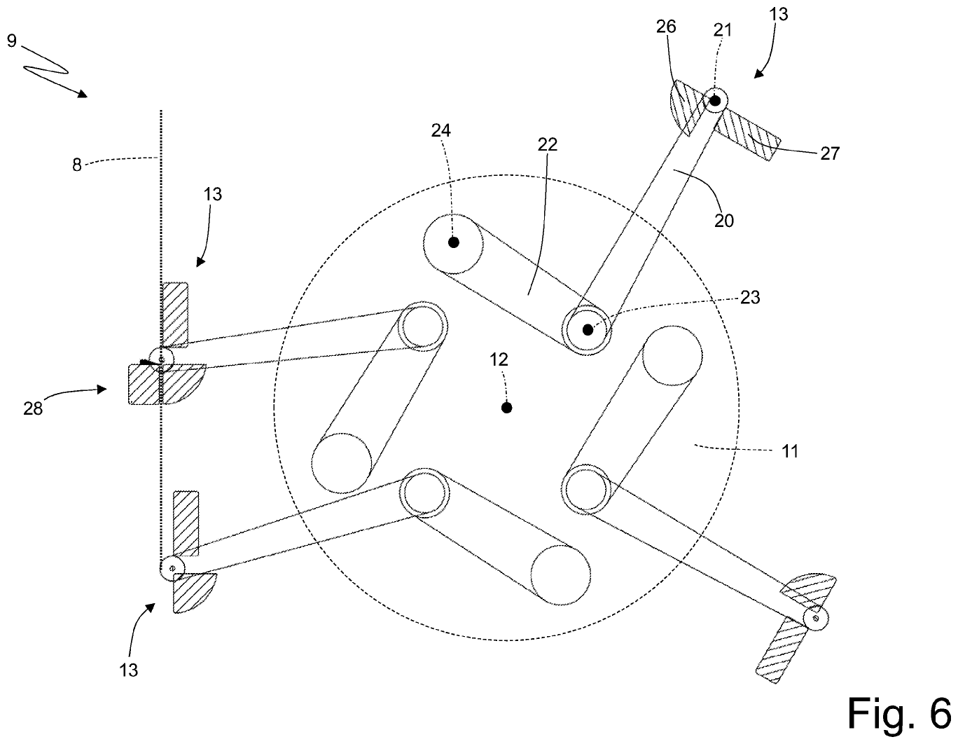

At this point and as shown in FIG. 6, the winding head 13 (shown on the top left of FIG. 6) which is not winding and is not engaging the composite material 8 continues its movement along the substantially straight (and vertical) segment of the processing path P2 (parallel to the feeding path P1) while the cutting device 28 completes its forth stroke in which the cutting device 28 follows, in a synchronous manner, the winding head 13 (i.e. it remains facing the winding head 13).

Towards the end of the substantially straight (and vertical) segment of the processing path P2 and as shown in FIG. 7, the winding head 13 (shown on the top left in FIG. 7) which is not winding and engaging the composite material 8 prepares to start its own winding: the cutting device 28 cuts the composite material 8 creating a new free end of the composite material 8 while the winding head 13 which is in front (shown on the bottom left in FIG. 7) is continuing to carry out the winding of the composite material 8; the back end of the composite material 8 downstream of the cut is being wound by the winding head 13 which is in front (shown on the bottom left in FIG. 7) while the head of the composite material 8 upstream of the cut (i.e. the new free end of the composite material 8 created by the cut) is being engaged by the holding device 14 of the winding head 13 facing the cutting device 28 (shown on the top left in FIG. 7).

In other words, the cutting device 28 is configured to cut the composite material 8 and hence create a new free end of the composite material 8 while the composite material 8 is still being wound by a previous winding head 13 (shown on the bottom left in FIG. 7) and a subsequent winding head 13 (shown on the top left in FIG. 7), which follows the previous winding head 13 along the processing path P2, is configured to grab the new free end of the composite material 8 and start the winding of the composite material 8 while the previous winding head 13 is still completing the winding of its own composite material 8.

According to a preferred embodiment, the drum 11 is configured to arrange the previous winding head 13 (shown on the bottom left in FIG. 7) and the next winding head 13 (shown on the top left in FIG. 7) at the minimum mutual distance along the processing path P2 at the instant in which the cutting device 28 cuts the composite material 8; in this way, the back end of the composite material 8 which is downstream of the cut and is wound by the previous winding head 13 (shown on the bottom left in FIG. 7) is short and therefore does not take on undesirable and potentially damaging positions even if its position is not controlled, i.e. even if left free for a few instants.

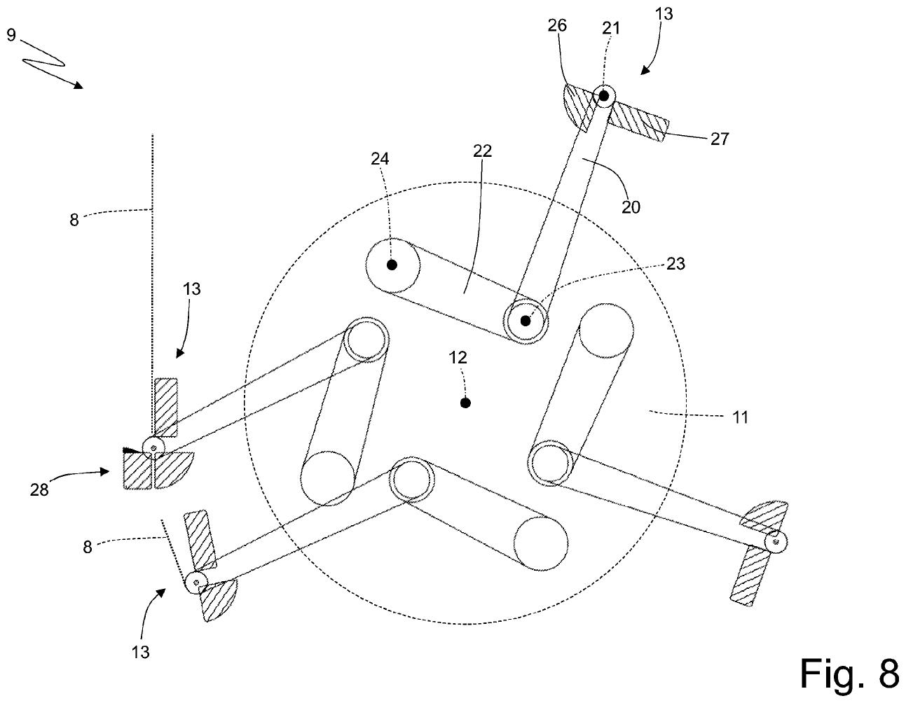

Subsequently and as shown in FIG. 8, the winding head 13 which is in front (shown on the bottom left in FIG. 8) has left the substantially straight (and vertical) segment of the processing path P2 and the cutting device 28 is now at the end of its forth stroke and is about to start the return stroke by which it leaves the winding head 13 (shown on the top left in FIG. 8) which has recently started the winding of its own composite material 8 and is now approaching a new winding head 13 (shown on the top right in FIG. 8) which will shortly start to cover the substantially straight (and vertical) segment of the processing path P2.

As mentioned above, the actuator device 31 is configured to have the cutting device 28 cyclically cover a forth stroke in which the cutting device 28 follows, in a synchronous manner, a winding head 13 along the substantially straight segment of the processing path P2 (parallel to the feeding path P1) and a return stroke in which the cutting device 28 moves back to a start position in order to follow, in a synchronous manner, a subsequent winding head 13; preferably, the cutting device 28 is configured to cut the composite material 8 at the end of the forth stroke.

Furthermore, as described above, the holding device 14 of each winding head 13 is configured to grab one end of the composite material 8 and then start to create the spiral winding immediately after the composite material 8 has been cut by the cutting device 28. In particular, the holding device 14 of the winding head 13 arranged closest to the cutting device 28 grabs one end of the composite material 8 and then starts creating the spiral winding immediately after the composite material 8 has been cut by the cutting device 28.

According to a preferred embodiment, when the composite material 8 is cut by the cutting device 28, the winding head 13 arranged closest to the cutting device 28 is located upstream of the cutting device 28 relative to the moving direction of the composite material 8.

As mentioned above, the feeding path P1 followed by the composite material 8 is straight and (preferably) vertical, while a segment of the processing path P2 followed by each winding head 13 is substantially straight and parallel to the feeding path P1: in fact, a segment of the processing path P2 followed by each winding head 13 is perfectly straight and parallel to the feeding path P1 followed by the composite material 8 up to the point where the winding head 13 starts the winding, whereas, from the point where the winding head 13 starts the winding, the processing path P2 followed by the winding head 13 must slightly (i.e. not substantially) deviate from the feeding path P1 to take into account the (gradually increasing) thickness of the winding of the composite material 8 (i.e. the winding head 13 must slightly deviate from the feeding path P1 as the thickness of the winding being formed increases in order to maintain the winding start point on the feeding path P1). 1s From another point of view, it may be argued that the segment which is (perfectly) straight and (perfectly) parallel to the feeding path P1 of the processing path P2 followed by each winding head 13 ends at the point where the winding head 13 starts winding, since from this point onwards the winding head 13 must progressively move away (even if not substantially) from the feeding path P1 followed by the composite material 8 in order to compensate for the (gradually rising) increase in thickness of the winding of the composite material 8.

As mentioned above, preferably in the initial and final part (i.e. for a small segment at the head and for a small segment at the back end), the composite material 8 consists only of the two overlapping separator bands 5 and 7 to increase the electrical insulation at the beginning and end of the cylindrical electrochemical cell 2. To achieve this result, the cutting devices 18 cyclically cut the corresponding conductor bands 4 and 6, which are stopped for a few moments, in relation to the separator bands 5 and 7, which instead continue to run in such a way as to create (small) zones along the composite material 8 without the conductor bands 4 and 6 (i.e. with only separator bands 5 and 7), which are arranged between the end of one winding and the beginning of the next winding.

In the preferred embodiment shown in the enclosed Figures, the feeding unit 10 is fixed and only the cutting device 28 is mounted in a movable manner to move along a segment of the processing path P2 followed by the winding heads 13. According to a different embodiment not shown, the entire feeding unit 10 is mounted in a movable manner to move back and forth along a segment of the processing path P2 followed by the winding heads 13; in this embodiment, the processing path P2 may have a straight segment and therefore the feeding unit 10 moves linearly back and forth, or the processing path P2 may not have a straight segment and therefore the feeding unit 10 is mounted in a rotary manner to rotate back and forth around the rotation axis 12 around which the drum 11 also rotates. In other words, an actuator device is provided which is configured to have the feeding unit 10 cyclically cover a forth stroke in which the feeding unit 10 follows, in a synchronous manner, a winding head 13 along a segment of the processing path P2 and a return stroke in which the feeding unit 10 returns to a start position in order to follow, in a synchronous manner, a subsequent winding head 13.

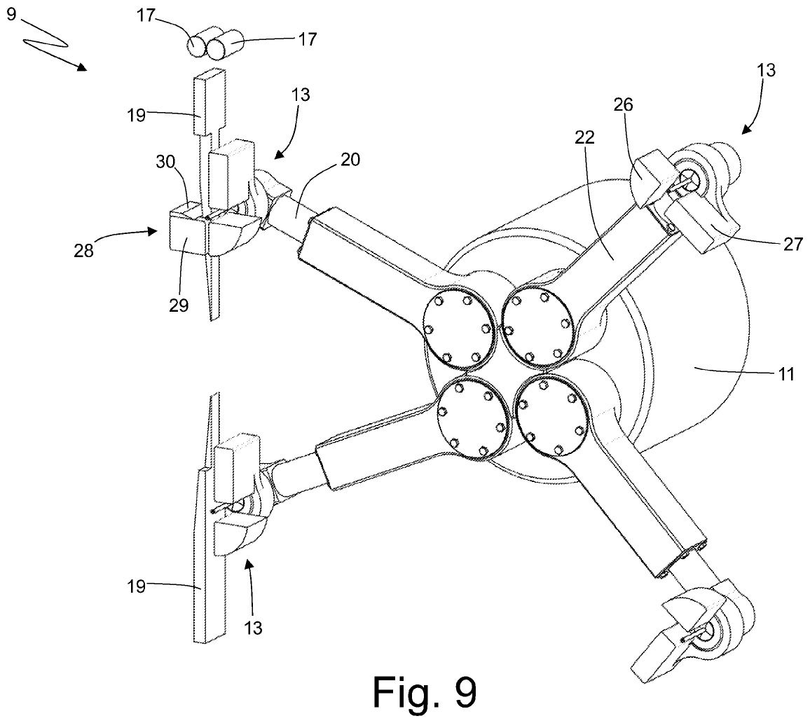

FIG. 9 shows a variant of the drum 11 which differs from the drum 11 shown in FIGS. 3-8 in the kinematic mechanism connecting the winding heads 13 to the drum 11: each winding head 13 always has, with respect to the drum 11, three degrees of freedom, but in the embodiment shown in FIGS. 3-9 these three degrees of freedom are obtained by means of three different rotations (around the rotation axes 21, 23 and 24) whereas in the embodiment shown in FIG. 9 these three degrees of freedom are obtained by means of two different rotations (around the rotation axes 21 and 24) combined with a linear translation (i.e. the two arms 20 and 22 are not hinged to each other, but are telescopically connected to each other so as to linearly translate one another).

The herein described embodiments can combine one another without departing from the scope of protection of the present invention.

The above described manufacturing machine 9 has several advantages.

Firstly, the manufacturing machine 9 described above allows to operate at a high production speed (measured as cylindrical electrochemical cells 2 produced in the unit of time) while ensuring high quality of the final product. In particular, the manufacturing machine 9 described above may operate at a minimum of 30-40 cylindrical electrochemical cells produced per minute while ensuring a high quality of the final product.

This result is obtained thanks to the possibility to optimally control (i.e. with a very high precision) the tension of the composite material 8: the tension of the composite material 8 always remains constant and equal to a desired value at all the winding manufacturing steps, and thus the windings are perfectly carried out even when operating at high production speeds. In other words, it has been observed that even small variations in the tension of the composite material 8 affect negatively the quality of the winding, especially when the winding is carried out at high speed and, in the manufacturing machine 9 described above, it is possible to maintain a perfectly constant tension of the composite material 8.

In the manufacturing machine 9 described above, it is possible to maintain a perfectly constant tension of the composite material 8 at all times, mainly because the feeding unit 10 is configured to move the composite material 8 at a constant moving speed at all times and thus without any interruption of the movement of the composite material 8; in fact, if the moving speed of the composite material 8 does not change, it is much easier to precisely control the tension of the composite material 8 and thus maintain the tension of the composite material 8 as constant. The fact that the drum 11 rotates around the rotation axis 12 with a continuous law of motion significantly contributes to maintaining a constant moving speed of the composite material 8 at all times.

The manufacturing machine 9 described above is particularly compact and offers optimum accessibility to all its components for adjustment, format change, maintenance and repair operations.

The manufacturing machine 9 described above allows to relatively easily and quickly change the format of the cylindrical electrochemical cells 2.

Finally, the manufacturing machine 9 described above is also of simple and cost-effective construction.

### LIST OF REFERENCE NUMBERS OF THE FIGURES

1 cylindrical battery
2 electrochemical cell
3 cylindrical container
4 conductor band
5 separator band
6 conductor band
7 separator band
8 composite material
9 manufacturing machine
10 feeding unit
11 drum
12 rotation axis
13 winding heads
14 holding device
15 rotation axis
16 unwinding devices
17 compression rollers
18 cutting device
19 fixed guides
20 arm
21 rotation axis
22 arm
23 rotation axis
24 rotation axis
25 actuating system
26 side board
27 side board
28 cutting device
29 side board
30 blade
31 actuator device
P1 feeding path
P2 processing path

1. A manufacturing machine (9) to manufacture a cylindrical electrochemical cell (2) including a spiral winding of a composite material (8) comprising at least two conductor bands (4, 6) and at least two separator bands (5, 7) overlapping one another, the manufacturing machine (9) comprising:
a plurality of winding heads (13), each of which supports a holding device (14), which is configured to grab an end of the composite material (8) and to rotate on itself around a first rotation axis (15) so as to obtain a spiral winding of the composite material (8);
a drum (11) which supports the winding heads (13) and is mounted so as to rotate around a second rotation axis (12) in order to move the winding heads (13) along a processing path (P2); and
a feeding unit (10) configured to feed the composite material (8) to the winding heads (13),
wherein the drum (11) is configured to rotate around the second rotation axis (12) with a continuous law of motion.

2. The manufacturing machine (9) according to claim 1, wherein the feeding unit (10) is configured to move the composite material (8) at a substantially constant moving speed.

3. The manufacturing machine (9) according to claim 1, wherein the feeding unit (10) is configured to move the composite material (8) without any interruption of the movement of the composite material (8).

4. The manufacturing machine (9) according to claim 1, wherein the feeding unit (10) is configured to move the composite material (8) along a straight feeding path (P1).

5. The manufacturing machine (9) according to claim 4, wherein the straight feeding path (P1) is arranged vertically and the feeding unit (10) is configured to move the composite material (8) from the top to the bottom.

6. The manufacturing machine (9) according to claim 4, wherein a segment of the processing path (P2) is substantially straight and parallel to the feeding path (P1).

7. The manufacturing machine (9) according to claim 1, wherein:
a segment of the processing path (P2) is substantially straight; and
each holding device (14) is configured to grab one end of the composite material (8) and then start the spiral winding of the composite material (8) while the corresponding winding head (13) moves along the substantially straight segment of the processing path (P2).

8. The manufacturing machine (9) according to claim 1, further comprising a first cutting device (28) configured to cut the composite material (8).

9. The manufacturing machine (9) according to claim 8, wherein:
the first cutting device (28) is configured to cut the composite material (8) and then create a new free end of the composite material (8) while the composite material (8) is still being wound by a first winding head (13); and
a second winding head (13) which follows the first winding head (13) along the processing path (P2) is configured to grab the new free end of the composite material (8) and start winding the composite material (8) while the first winding head (13) is still completing winding its own composite material (8).

10. The manufacturing machine (9) according to claim 9, wherein the drum (11) is configured to arrange the first winding head (13) and the second winding head (13) at the minimum mutual distance along the processing path (P2) at the instant in which the first cutting device (28) cuts the composite material (8).

11. The manufacturing machine (9) according to claim 8, wherein:
the feeding unit (10) comprises two opposite compression rollers (17) between which the composite material (8) is passed; and
the first cutting device (28) is arranged downstream of the two compression rollers (17).

12. The manufacturing machine (9) according to claim 8, wherein the first cutting device (28) is mounted in a movable manner to move back and forth along a segment of the feeding path (P1).

13. The manufacturing machine (9) according to claim 12, comprising an actuator device (31) configured to have the first cutting device (28) cyclically cover a forth stroke, in which the first cutting device (28) follows, in a synchronous manner, a winding head (13) along a segment of the processing path (P2) and a return stroke in which the first cutting device (28) moves back to a start position in order to follow, in a synchronous manner, a following winding head (13).

14. The manufacturing machine (9) according to claim 13, wherein the first cutting device (28) is configured to cut the composite material (8) at the end of the forth stroke.

15. The manufacturing machine (9) according to claim 13, wherein the holding device (14) of each winding head (13) is configured to grab one end of the composite material (8) and then start creating the spiral winding immediately after the composite material (8) has been cut by the first cutting device (28).

16. The manufacturing machine (9) according to claim 13, wherein the holding device (14) of the winding head (13) arranged closest to the first cutting device (28) is configured to grab one end of the composite material (8) and then start creating the spiral winding immediately after the composite material (8) has been cut by the first cutting device (28).

17. The manufacturing machine (9) according to claim 13, wherein, when the composite material (8) is cut by the first cutting device (28), the winding head (13) arranged closest to the first cutting device (28) is located upstream of the first cutting device (28) relative to the moving direction of the composite material (8).

18. The manufacturing machine (9) according to claim 8, wherein the first cutting device (28) comprises:
a first side board (29) which has a face parallel to a feeding path (P1) followed by the composite material (8); and
a blade (30) which is mounted in a sliding manner relative to the second side board (26).

19. The manufacturing machine (9) according to claim 18, wherein each winding head (13) comprises a second side board (26) which, along a segment of the processing path (P2), faces the first side board (29) to define with the first side board (29) a channel where the composite material (8) is located.

20. The manufacturing machine (9) according to claim 19, wherein each winding head (13) comprises a third side board (27) which is arranged beside the holding device (14) on the opposite side relative to the second side board (26).

21. The manufacturing machine (9) according to claim 1, wherein the feeding unit (10) comprises two second cutting devices (18), each of which is configured to cut only a corresponding conductor band (4, 6).

22. The manufacturing machine (9) according to claim 21, wherein:
the feeding unit (10) comprises two opposite compression rollers (17) between which the composite material (8) is passed; and
each second cutting device (18) is arranged upstream of the two compression rollers (17).

23. The manufacturing machine (9) according to claim 1, wherein each winding head (13) is mounted in a rotary manner on the drum (11) to rotate, relative to the drum (11) itself, around a third rotation axis (21) parallel to the second rotation axis (12).

24. The manufacturing machine (9) according to claim 1, wherein each winding head (13) is mounted in a rotary manner on the drum (11) to rotate, relative to the drum (11) itself, around a third rotation axis (21) parallel to the second rotation axis (12) and around a fourth rotation axis (23) parallel to the second rotation axis (12).

25. The manufacturing machine (9) according to claim 1, wherein each winding head (13) is mounted in a rotary manner on the drum (11) to rotate, relative to the drum (11) itself, around a third rotation axis (21) parallel to the second rotation axis (12), around a fourth rotation axis (23) parallel to the second rotation axis (12), and around a fifth rotation axis (24) parallel to the second rotation axis (12).

26. The manufacturing machine (9) according to claim 25, wherein:
each winding head (13) is hinged at an end of a first arm (20) so as to rotate, relative to the first arm (20), around the fifth rotation axis (24);
an end of the first arm (20) opposite the winding head (13) is hinged at an end of a second arm (22) so as to rotate, relative to the second arm (22), around the fourth rotation axis (23); and
an end of the second arm (22) opposite the first arm (20) is hinged to the drum (11) so as to rotate, relative to the drum (11), around the third rotation axis (21).

27. The manufacturing machine (9) according to claim 1, wherein the feeding unit (10) is mounted in a movable manner so as to move back and forth along a segment of the processing path (P2).

28. The manufacturing machine (9) according to claim 27, wherein the feeding unit (10) is mounted in a rotary manner so as to rotate around the second rotation axis (12).

29. The manufacturing machine (9) according to claim 27, further comprising an actuator device configured to have the feeding unit (10) cyclically cover a forth stroke, in which the feeding unit (10) follows, in a synchronous manner, a winding head (13) along a segment of the processing path (P2), and a return stroke, in which the feeding unit (10) moves back to a start position in order to follow, in a synchronous manner, a following winding head (13).

30. A manufacturing method to manufacture a cylindrical electrochemical cell (2) including a spiral winding of a composite material (8) comprising at least two conductor bands (4, 6) and at least two separator bands (5, 7) overlapping one another, the manufacturing method comprising:
having a first holding device (14), which is configured to grab an end of the composite material (8) and is supported by a winding head (13), rotate on itself around a first rotation axis (15), so as to create a spiral winding of the composite material (8);
moving a plurality of winding heads (13) along a processing path (P2) by means of a drum (11), which supports the winding heads (13) and is mounted in a rotary manner so as to rotate around a second rotation axis (12); and
feeding the composite material (8) to the winding heads (13) by means of a feeding unit (10),
wherein the drum (11) is configured to rotate around the second rotation axis (12) with a continuous law of motion.

31. The manufacturing method to manufacture an electrochemical cell (2) according to claim 30, wherein said feeding the composite material (8) to the winding heads (13) comprises moving the composite material (8) at a substantially constant moving speed.

32. The manufacturing method to manufacture an electrochemical cell (2) according to claim 31, wherein said feeding the composite material (8) occurs without interruption of the movement of said composite material.

33. The manufacturing method to manufacture an electrochemical cell (2) according to claim 30, wherein said composite material (8) moves along a straight moving path.

34. The manufacturing method to manufacture an electrochemical cell (2) according to claim 30, further comprising moving said feeding unit back and forth along a segment of the processing path.

35. A battery (1) comprising an electrochemical cell (2) manufactured according to the method of claim 30.
